(19) United States
(12) Patent Application Publication
(10) Pub. No.: US 2008/0311550 A1
(43) Pub. Date: Dec. 18, 2008

(54) TEST MATERIALS MOVEMENT MONITORING SYSTEM AND METHOD

(76) Inventors: Michael Giambrone, LaGrange, IL (US); Michael Arlas, Chicago, IL (US); James O'Brien, Wayne, IL (US); Andrew Bedno, Chicago, IL (US)

Correspondence Address: COOK ALEX LTD, SUITE 2850, 200 WEST ADAMS STREET, CHICAGO, IL, 60606, US

(21) Appl. No.: 12/049,466

(22) Filed: Mar. 17, 2008

Related U.S. Application Data
(60) Provisional application No. 60/895,177, filed on Mar. 16, 2007.

(51) Int. Cl. G09B 5/00; G09B 7/00

(52) U.S. Cl. 434/353; 434/362

(57) ABSTRACT

A method and system for monitoring the movement of academic test materials and/or their shipping containers while providing a complete chain of custody of those test materials and shipping containers. Test materials include paper based and electronic based tests and related items such as answer keys, teacher notes, and study guides. The providers of the test materials include, but may not be limited to, test publishers, state and federal agencies, specialized test developers, and distributors of tests created by other parties. Users include, but are not limited to, school districts, individual schools, students, corporations, and other individuals, as well as the test publisher, state and federal agencies, and other test producers. The tracking is done through the scanning of bar codes or RFID devices printed on or otherwise affixed to test materials and the test material shipping containers. The method and system monitors the chain of custody of the test materials throughout the distribution and return paths.

### CROSS-REFERENCE TO RELATED APPLICATIONS

This patent application claims the benefit of priority of U.S. Provisional Patent Application No. 60/895,177, filed Mar. 16, 2007. The full disclosure of U.S. Provisional Patent Application No. 60/895,177 is hereby incorporated herein by reference.

### BACKGROUND OF THE INVENTION

The present invention relates to a system and method for monitoring chain of custody as standardized test materials move from a test publisher to test takers and back to the publisher or other test scoring entity, by monitoring individual test materials and test material shipping containers throughout the process and reporting variances to the appropriate contacts.

The federal No Child Left Behind Law (NCLB), and other state and local regulations, require that grammar, junior high, and high school students be tested annually to determine their learning progress. The tests are standardized to enable results to be compared. The test results measure and compare the relative performance of the students, their teachers, the individual schools, the school districts, and the states. The testing process consists of administering identical tests to all students in the same grade, within a state, at approximately the same time. In addition to schools, entities such as government agencies, corporations, professional associations, certification bodies and others also require the distribution and subsequent return and scoring of standardized test materials.

The process of distributing standardized tests from the test producer to the ultimate user, the person who takes the test, and then back to the test producer or other scoring entity for test scoring involves handling by many parties, and demands an efficient, secure, speedy and error free process during and throughout all links in the chain of custody. In the case of academic testing, typically the test papers are ordered by the school district, based on student populations in each class, known at a certain date. The exact quantity ordered of each test is then determined, and the test materials are packed by school grade for shipment at the producer or distributor warehouse; then sent to the school district, optionally by a third party carrier, and hand recorded when received by the school district; then sent to the individual school, and hand recorded when received by the individual school; then distributed to the individual teacher or other test monitor, and hand recorded by each individual monitor monitoring the test; and then given to each student.

After completion of the test, the test movement process and chain of custody progress in reverse. The monitor typically gathers the tests, manually checking for any missing papers and returns them to the school testing administrator. The school administrator manually checks again for missing papers, and places them in a shipping carton. The cartons are sealed and sent to the test producer or other scoring entity for scoring, optionally through the school district. The scoring entity scores the tests and reports the results to the school district and/or individual schools within four to six weeks. Using the prior technology, the school district, the state, and the producer would not discover evidence of any missing test materials until about four to eight weeks after the tests were administered.

The process of monitoring the movement of the test materials from one party to another is typically conducted through a slow and frequently inaccurate manual process. In academics, when test materials are distributed to a school, it is common for the process to occasionally be interrupted by lost or unaccounted for test materials and their shipping containers. Missing test materials are a serious problem, as described below.

There are many possible points in the test material distribution and return process for a container or piece of test material to be lost or for there to be another shipping discrepancy. One possible point of loss may be that the test materials are not actually sent by the producer or distributor to the school, i.e. an error is made in the order entry, selection, packing, or shipping process. Another possible point of missing test materials occurs at the school district and/or at the school, whereby the shipping containers or test materials are incorrectly received, misdirected or destroyed, or when select test materials are lost following removal from the shipping containers. Still another potential point of loss is in the classroom, when the monitor fails to accurately distribute to or collect the test materials from the test taking students. Yet another possible point of loss is when the test materials are packed into shipping containers for return to the test producer or other scoring entity, and either improperly packed, mislabeled, or lost in transit. Another possible point of loss occurs at the test producer or other scoring entity, where test materials may be lost or misplaced following their removal from the shipping containers before scoring. Other possible points of loss exist along the chain of custody distribution and return paths.

Test materials can become lost for numerous reasons. Test materials may be missing simply due to human error at any point in the lengthy process. Miscount of test materials can occur at any step in the distribution or return paths. The possibility that parties steal test materials also exists. School administrators and teachers have been known to steal test materials so that the materials could be used to train the next class to score better results in a later test, thereby falsely giving the impression that the school or teacher is performing more effectively. Teachers have been known to discard or destroy test materials received from particular test taking students who are projected to have poor test results, thereby raising the average results from the balance of the class. Removing the projected low scoring tests results in the class average score increasing, making the teacher and school performance appear more effective.

There are numerous negative consequences associated with missing test materials. Most importantly, the progress and performance of the students victimized by missing tests are not known. Schools, parents, and tax payers rely upon standardized tests to determine the progress of every child. Additionally, the consequences include unresolved suspicion of theft by any one of the many participants in the distribution, testing, and test material return processes. This jeopardizes the integrity of the entire chain of custody path, and undermines the intent of the NCLB law. The most serious consequence of lost testing materials is that a student is not given credit for his work and may be refused advancement. Another consequence of lost test materials is that underperforming schools may avoid consequences and remain open while teachers, who are not adequately instructing their students, remain employed and/or untrained.

While some prior technology involved scanning of test materials, such scanning typically was completed only on a limited basis and by the test publishers strictly within the confines of their businesses. If there was any discrepancy noted upon return of the distributed test materials to the test publisher, it could not be determined where along the route (chain of custody path) and under what circumstances such discrepancy occurred. In addition, the reporting of tracking information was generally available only locally for access by and perception by the scanning party and reporting of tracking information was substantially limited. Such systems did not provide means for determining the party or parties responsible for test material discrepancies. One such system is disclosed in publication number US 2006/0265170 to Gedlinske et al. in which the system is focused only on prioritizing the processing of standardized tests within a single facility and only for scoring purposes. The system disclosed by Gedlinske et al. concerns internal tracking only and does not track test materials or packages when they are transferred between separate and geographically remote facilities. The system disclosed by Gedlinske et al. also is not concerned with the reporting of tracking information to third parties, and even more particularly the presentment of information concerning the tracking of packages on a system website that is accessible by select personnel, such as system administrators, test publisher administrators, state school administrators, school district administrators, and individual school administrators.

With the technology described herein, all test material producers either print a bar code number or affix a radio frequency identification (RFID) transponder on each test booklet and answer sheet, though other methods of tracking or monitoring test materials could alternatively be used. Some of the bar codes printed or affixed to test materials and their shipping containers may be unique, and as such, may identify a particular piece of testing material. During the course of a school year, schools may use tests from more than one test producer. Different test producers may have their own unique numbering and bar code or RFID systems. The invention is capable of accepting various codes or identifiers from multiple test producers.

A school or other test administrator specifies how many pieces of test materials must be sent for each grade or other group of anticipated test takers, thereby indicating how many pieces of test materials should be packed in shipping containers and sent by the test producer. It is possible that the producer will commit one or several errors in packing the test materials, and schools will receive too many or too few tests. A preferred aspect of the invention requires that the shipping containers and test materials are identified by bar code numbers or RFID transponders, and that test producers scan each shipping container and each piece of test material to be contained therein prior to sealing the container for shipment. The data is electronically reported to a system database and may include the shipping container bar code data, test material bar code data, and other pertinent data for each school and, in some cases, each student. This data may be made available on a website where it is available to be compared to data collected by users employing hand held laser scanners or other scanning devices and reviewed at the website by approved users only through known security measures (e.g., log-in processes). Personnel at test material producers, schools or school districts typically will have access limited only to the data pertaining to their particular tests.

It is preferred that the bar code or RFID data on the shipping containers on each piece of test material be scanned at each point of handling by the school district and/or school, and in some cases, a third party freight carrier. The invention has the ability to accept bar code and RFID symbology used by any test material producer. The data collected by scanning the bar codes or RFID transponders is uploaded to the system database and may then be published on the website for review by approved users. Any discrepancy in the count or content of the data scanned versus the data originally provided by the test material producer will be immediately detected and highlighted by the technology, and may be made viewable to all approved users of the website. An e-mail alert or other type of notification may be sent to the affected parties whenever a discrepancy has been detected. In addition, data may be posted on a database driven system website

When test materials are distributed to students, the individual materials may be scanned by the teacher or other test monitor, thereby linking a particular piece or pieces of test material to a specific student taking the test on that day. The scanned data can then be transmitted to the system database and content indicative thereof may be uploaded to the website.

After completion of the test, the test monitor may collect and scan each piece of test material to verify accuracy. Thereafter, the test monitor may deliver all completed test materials to the school test administrator. The administrator scans the shipping container shipping label bar code and then scans each piece of test material as it is packed into such container. The scanning of every shipping container, and then each piece of test material packed into it, continues until all test materials are packed for shipment back to the test producer or other scoring entity, either directly or through the school district. These actions ensure that all shipping containers and, at appropriate times, all pieces of test material are scanned to confirm the content of each shipping container at appropriate transition points along the return path, providing for a secure and reliable chain of custody.

In addition to completed tests, any unused test materials may also be scanned and returned to the test producer in bar code numbered shipping cartons. Data pertaining to all used and unused test material scan tracking is transmitted to the system database and associated content may be posted on the website and viewable by approved users. Accordingly, the affected parties are notified if there is any indication of missing materials. E-mail alerts and other notifications may also be sent by the system to the affected parties to indicate the presence of exceptions. The scanned data and content presented on the website also informs the test producer or other scoring entity and other interested parties that test materials in certain schools have been packed and are ready for shipment and pickup by freight carriers, thus allowing for early and efficient return scheduling.

After the test materials are packed in shipping containers and are ready for shipment to the test producer or other scoring entity for scoring, the container labels may be scanned when the shipment is ready to leave the school, indicating that the containers are being shipped. The scanned data is uploaded to the system database and is available for presentment on a system website. Content indicative thereof is used to determine whether there are any missing containers, and if so, information indicative thereof may be published on the website to alert approved users. Notifications may be sent to all appropriate parties indicating that there is a missing container exception. These steps may also be performed on the school district or regional administrator level, if applicable.

Following receipt of the shipping containers by the test producer or other scoring entity, each container barcode label is scanned, and the scanned data is transmitted to the system database and associated content may be uploaded to the website, available for review by the authorized parties. Any discrepancy from expected shipping data is identified, and the affected parties may be notified, for example, by an e-mail alert or posted on the database driven system website.

Each test material may be scanned when removed from its shipping container. Appropriate data pertaining to the scanned data is transmitted to the system database and content indicative of received data may be uploaded to the website, and affected parties may be notified of any exceptions.

As each individual test is scored by the test producer or other scoring entity, its barcode is read and the test material barcode data is transmitted to the system database for optional upload to the website. Any exceptions caused by a missing test are identified, and the affected parties may be notified.

A method and system for securely monitoring the chain of custody of test materials and the test materials shipping containers at every step of the distribution path from the test producer to the ultimate test taker or student is provided. A method and system for securely monitoring the chain of custody of test materials at every step of the return path from the ultimate test taker or student to the test producer or other test scoring entity is also provided. The technology described herein constitutes a method and system of securely monitoring the status of test materials throughout their chain of custody.

### SUMMARY OF THE INVENTION

The present invention is directed to a system for and method of tracking test materials along the distribution path from the test producer/publisher to the test takers and along the return path from test takers back to the test producer/publisher or other test scoring entity. The route or path of test materials may include distribution centers or processing facilities of the test producers, the customers, and third party distributors or service providers. Test materials and their associated cartons are scanned at each transition along such routes and the relevant shipping data may be posted to a website. Variances are detected at each transition along the paths and the appropriate contacts may be notified of the discrepancies. Select tracking information may be reported to all approved persons.

The present invention provides systems and methods for monitoring chain of custody of standardized test materials. The present invention allows shipping containers and individual test materials to be scanned and monitored at each transition point of the test material distribution and return paths. The present invention further allows the scanned information to be posted to a website. Further, the present system allows for variances to be identified and for the appropriate contacts to be notified of any such variances. The present invention also allows the test materials to be delivered throughout the process by a common freight carrier, internal personnel, or a combination of common freight carriers and internal personnel.

### BRIEF DESCRIPTION OF THE SEVERAL VIEWS OF THE DRAWING

Reference will frequently be made to the following figures, in which like reference numerals refer to like components, and in which:

FIG. 1 is a diagrammatic view of a test materials movement process having a test material distribution path and a test material return path; and

FIG. 2 is a diagrammatic view of a test materials movement monitoring system employing principles of the present invention.

### DETAILED DESCRIPTION OF THE INVENTION

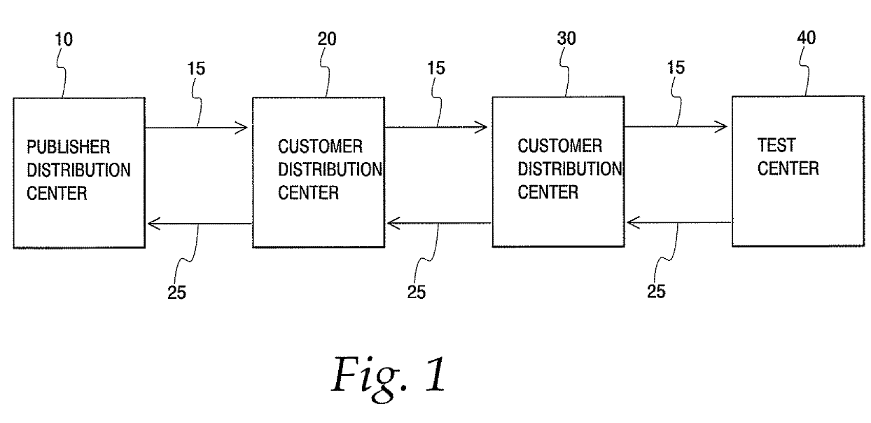

FIG. 1 generally illustrates a chain of custody for test materials. As illustrated, the test materials are selected and prepared for shipment at the publisher distribution center 10, such as by packing test materials within shipping containers and sealing such containers. The test materials are distributed from the publisher distribution center 10 to the test site or center 40 along a plurality of distribution path segments 15 to permit individuals to complete the test. The test materials are then returned to the publisher distribution center 10 along a plurality of return path segments 25 for scoring. Alternatively, the test materials may be delivered to a third party scoring entity for scoring (not shown).

A third party carrier may be used to deliver the test materials along select distribution path segments 15 and select return path segments 25. In particular, a carrier may pick up the test materials from one center and deliver it to the next. For example, a carrier may pick up test materials sorted and packed in shipping containers from the publisher distribution center 10 and deliver the containers containing such test materials to a first customer distribution center 20, which may represent a school district, for instance. The first customer distribution center 20 is located geographically remote from the publisher distribution center 10. At the first customer distribution center 20, the test materials may be removed from their shipping containers and sorted and prepared for shipment to a second customer distribution center 30, which may represent a particular school, for instance, and is located geographically remote from the first customer distribution center 20.

A carrier may then pick up shipping containers of test materials from the first customer distribution center 20 and deliver such containers to the second customer distribution center 30. At the second customer distribution center 30, the test materials may be removed from their shipping containers and sorted and prepared for delivery (by packing in new shipping containers, for example) to each test site or center 40. which may represent a school classroom, for instance. The test materials may then be delivered to the test site or center 40. In certain contexts, a carrier may provide such delivery.

At the test centers 40, the test materials are provided to the test takers in a controlled environment, typically under the supervision of a test monitor, and the tests are completed by the test takers.

The test material return process thereafter begins by reversing the steps of the test material distribution process and returning the tests to the publisher distribution center 10 along designated return path segments 25. The test materials are gathered from the test takers at the test centers 40 and prepared for delivery to the second customer distribution center 30. A carrier may be used to provide this delivery in appropriate contexts.

The test materials are picked up from the test centers 40 and delivered to the second customer distribution center 30. Test materials from all test centers 40 returning tests through second customer distribution center 30 may be collected, sorted and prepared for shipment to the first customer distribution center 20.

At the first customer distribution center 20, the test materials are collected, sorted and prepared for shipment to the publisher distribution center 10. These test materials may be picked up and delivered to the publisher distribution center 10, which may serve as a scoring center. Alternatively, the test materials may be sent to a scoring center controlled by a third party scoring entity.

The completed test materials are then scored and the results are reported to the designated authorized customer representatives. As will be appreciated, at each transition between one of the centers 10, 20, 30, 40 and each distribution path segment 15, the test materials may move from the custody and control of one party to the custody and control of another party.

It will be appreciated that first and second customer distribution centers 20, 30 may represent any level of hierarchy of the test material movement paths, such as state government school headquarters, school districts or individual schools.

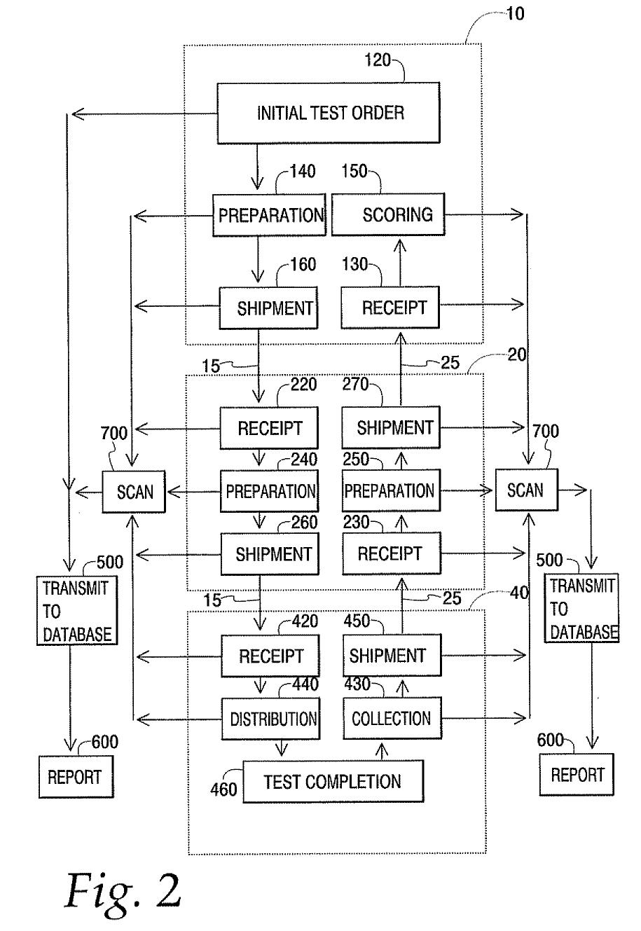

FIG. 2 illustrates a test materials movement monitoring system generally designated 100 and including the publisher distribution center 10, the first customer distribution center 20, the test center 40, distribution path segments 15 and return path segments 25. While only one customer distribution center 20 is illustrated and described, this is done for illustrative purposes only and to simplify this description it will be appreciated that multiple or no customer distribution centers may be included.

In the test materials movement monitoring system 100, the entire chain of custody may be monitored as test materials are sent from the test publisher distribution center 10 to the testing center 40 and, once completed, returned to the publisher distribution center or another scoring center controlled by a third party scoring entity.

Data regarding monitoring of test materials movement is reported electronically to system users by make such data available for viewing through a system website. Authorized persons are permitted to view data presented on the system website. The data viewable by authorized persons may depend upon the classification of each particular person. For example, the system administrators may be able to view all data presented on the system website. On the other hand, the test publisher administrators might only be able to view data pertaining to test materials that were created or published by their respective test publishers. Similarly, state administrators might only be able to view data pertaining to test materials that have been designated for their respective states. School district administrators might only be able to view data pertaining to test materials that have been designated for their respective school districts. And individual school administrators might only be able to view data pertaining to test materials that have been designated for their respective schools.

Through the use of the system website, users may perform a variety of functions, such as running reports on stored data, searching data records, printing unique identifiers, and personalizing identifiers to particular test monitors or students (as described in further detail below). In addition, the data presented to users on the system website may be presented in a hierarchical manner. A summary web page may be used to identify shipping containers and test materials received by first customer distribution centers 20, shipping containers and test materials received by second customer distribution centers 30, shipping containers and test materials packed and sent from such customer distribution centers, shipping containers and test materials packed and returned for scoring, and shipping containers and test materials received by the scoring center. It will be appreciated that additional web pages may be used to provide details related to the data presented on the summary web page and may be accessed for viewing by executing a URL request, such as through use of the well known mouse point and click techniques common with personal computer software operating systems.

In order to track and monitor test materials, scanning operations are performed and scanned data is transmitted to a system database for electronic storage, permitting further processing and/or presentment on the system website. Scanning is preferably carried out by hand-held scanning devices, and such devices may be connected to a distributed communication network such as the internet after performing scanning operations. When connected, the scanning devices are permitted to transfer scanned data to the system database, which may be located at a central processing center.

Command identifiers such as unique bar codes or RFID transponders may be used throughout the process. For example, prior to using a hand-held scanning device for purposes of the monitoring system, it may be desired to require scan of a scanner setup bar code. Other command bar codes could be used to identify the status of the items to be scanned. Such dedicated identifiers could be used to identify that subsequent scanning operations pertained to packing of test materials within a shipping container, shipping test materials out, receiving test materials, unpacking shipping containers and the like.

In another example of dedicated, unique identifiers, bar codes or RFID transponders could be used to associate a particular test monitor to whom the test materials should be or were delivered. The unique test monitor identifier could be scanned, followed by scanning each test material provided to that test monitor.

Another example of dedicated, unique identifiers would use bar codes or RFID transponders to identify particular test takers slated to use particular test materials during test taking. For each test taker, bar codes pertaining to that particular test taker could be placed on the test materials to be used by him/her and scanned just prior to providing the test materials to him/her.

All scanning operations preferably include a date and time stamp, in addition an identification of the location of the scan. Use of a date and time stamp provides for precision in the monitoring process and removes doubt and confusion in the process.

The initial test order is received by the publisher from the customer, or provided by the publisher, as represented by block 120. This initial test order 120 may specify how many tests of what particular type are to be delivered to what particular test centers 40 through what particular customer distribution centers 20, for example.

Data pertaining to the initial test order 120 is transmitted to a system database for electronic storage and available for processing and/or presentment on a system website, as represented by block 500. The initial test order data may be electronically reported to users of the system authorized to receive such data, as represented by block 600. Throughout this description it will be appreciated that the electronic reporting function represented by block 600 may be carried out in a variety of ways, including posting the data on a system website and granting access to such website by authorized users. The electronic reporting function represented by block 600 may also be carried out by sending email notifications to the authorized users. The electronic reporting function may alternatively include both posting to a system website and sending out email notifications.

The test materials have individual bar codes or radio frequency identification transponders for identification. The test materials are prepared for shipment at the test publisher distribution center 10, as represented by block 140. In particular, groups of test materials to be delivered to the customer distribution center 20, according to the test order 120, are packed in publisher distribution center shipping containers. The bar code or RFID transponder for each test material is scanned, preferably with hand-held scanners, prior to placement within a publisher distribution center shipping container, as represented by block 700. Each such shipping container may also have a bar code or RFID transponder associated therewith, which may be placed directly on the shipping container or may be placed on a pallet or similar structure used to carry out delivery of a plurality of shipping containers. In the case where the bar code or RFID transponder associated with a particular publisher distribution center shipping container is placed on a pallet or similar structure, the bar code or RFID transponder may be used to identify a plurality of such shipping containers. Data pertaining to the quantity of test materials and/or the identity of each test material packed within a specific publisher distribution center shipping container or within one of a plurality of such shipping containers is transmitted to the system database for electronic storage and available for processing and/or presentment on a system website, as represented by block 500.

After a publisher distribution center shipping container has been filled, or after the final test material designated for shipment to the customer distribution center 20 has been packed within such a shipping container, the shipping container is sealed for shipment. Bar code or RFID transponder associated with one or more publisher distribution center shipping containers may be scanned, as represented by block 700, and data pertaining to the identity of such shipping containers and/or their contents is transmitted to the system database for electronic storage and available for processing and/or presentment on a system website, as represented by block 500. The transmitted scanned data also may identify the quantity of the publisher distribution center shipping containers and test materials being sent from publisher distribution center 10.

This data may then be electronically reported to users authorized to receive such information, as represented by block 600. This data may also, or alternatively, be compared with data from the initial test order to identify any variance from what was intended to be sent from publisher distribution center 10 in that particular shipment. Any such variance may be electronically reported immediately to users authorized to receive such information, as also represented by block 600, to alert the users of errors and the source of errors within the test materials chain of custody. This alert may be in the form of an email notification and/or posting of data on a database driven system website.

A carrier may pick up and attend to shipment of the publisher distribution center shipping containers from the publisher distribution center 10, as represented by block 160, along distribution path segment 15 to the customer distribution center 20. The carrier may scan the bar codes or RFID transponders associated with the publisher distribution center shipping containers (block 700).

In response, data indicating that the associated shipping containers have been received by the carrier for shipment is transmitted to the system database for electronic storage (block 500) and available for processing and/or presentment on a system website. This data may then be reported to users authorized to receive such information, as represented by block 600. This data may also, or alternatively, be compared with previously scanned data and any variance may be electronically reported immediately to users through an appropriate alert notification, such as an email alert or posting data on a system website.

The carrier then may deliver the publisher distribution center shipping containers and the test materials contained therein to the customer distribution center 20, as represented by block 160. At the customer distribution center 20, the shipping containers are received (block 220), and the bar codes or RFID transponders associated with the shipping containers are scanned (block 700). Data indicating that the associated publisher distribution center shipping containers have been delivered to and received by the customer distribution center 20 is transmitted to the system database for electronic storage (block 500) and available for processing and/or presentment on a system website. This data may then be reported to users authorized to receive such information, as represented by block 600. This data may also, or alternatively, be compared with data previously generated identifying the publisher distribution center shipping containers slated for delivery to customer distribution center 20, and any variance may be reported immediately to users through an appropriate alert notification, such as an email alert or posting data on a system website.

The publisher distribution center shipping containers may be used to ship the test materials to the test centers 40 and handled in the manner suggested herein. Alternatively, the publisher distribution center shipping containers may be opened and the test materials shipped therein may be removed for further sorting or processing prior to delivery to test centers 40, as represented by block 240. The test materials are scanned individually upon removal from the publisher distribution center shipping containers (block 700) and data is thereby generated indicating which test materials were received in which shipping containers. This data is transmitted to the system database for electronic storage (block 500) and available for processing and/or presentment on a system website. This data may then be electronically reported to users authorized to receive such information, as represented by block 600. This data may also, or alternatively, be compared with data previously generated that identifies the content of each publisher distribution center shipping container slated for delivery to customer distribution center 20, and any variance may be electronically reported immediately to users through an appropriate alert notification such as an email alert or posting data on a database driven system website.

Test materials are thereafter further prepared for delivery to individual test sites or centers 40, as also represented by block 240. In particular, groups of test materials to be delivered to the test centers 40, according to the test order, are packed in customer distribution center shipping containers. The bar code or RFID transponder for each test material is scanned prior to placement within a customer distribution center shipping container, as represented by block 700. Each such shipping container may also have a bar code or RFID transponder associated therewith, which may be placed directly on the shipping container or may be placed on a pallet or similar structure used to carry out the delivery of a plurality of shipping containers. In the case where the bar code or RFID transponder associated with a particular customer distribution center shipping container is placed on a pallet or similar structure, the bar code or RFID transponder may be used to identify a plurality of such shipping containers. Data pertaining to the quantity of test materials and/or the identity of each test material packed within a specific customer distribution center shipping container or within one of a plurality of such shipping containers is transmitted to the system database for electronic storage and available for processing and/or presentment on a system website, as represented by block 500.

After a customer distribution center shipping container has been filled, or after the final test material designated for shipment to the test center 40 has been packed within such a shipping container, the shipping container is sealed for shipment. Bar code or RFID transponder associated with one or more customer distribution center shipping containers may be scanned, as represented by block 700, and data pertaining to the identity of such shipping containers and/or their contents is transmitted to the system database for electronic storage and available for processing and/or presentment on a system website, as represented by block 500. The transmitted scanned data also may identify the quantity of the customer distribution center shipping containers and test materials being sent from the customer distribution center 20.

This data may then be electronically reported to users authorized to receive such information, as represented by block 600. This data may also, or alternatively, be compared with data from the initial test order and data from what was received at the customer distribution center 20 to identify any variance. Any such variance may be electronically reported immediately to users authorized to receive such information, as also represented by block 600, to alert the users of errors and the source of errors within the test materials chain of custody such as an email alert or posting data on a system website.

A carrier may pick up and attend to shipment of the customer distribution center shipping containers from the customer distribution center 20, as represented by block 260. The carrier may scan the bar codes or RFID transponders associated with the customer distribution center shipping containers (block 700).

In response, data indicating that the associated shipping containers have been received by the carrier for shipment is transmitted to the system database for electronic storage (block 500) and available for processing and/or presentment on a system website. This data may then be reported to users authorized to receive such information, as represented by block 600. This data may also, or alternatively, be compared with previously scanned data and any variance may be electronically reported immediately to users through an appropriate alert notification such as an email alert or posting data on a system website.

The carrier then may deliver the customer distribution center shipping containers and the test materials contained therein to the test center 40 along distribution path segment 15, as represented by block 260. At the test center 40, the customer distribution center shipping containers are received (block 420), and the bar codes or RFID transponders associated with the shipping containers are scanned (block 700). Data indicating that the associated customer distribution center shipping containers have been delivered to and received by the test center 40 is transmitted to the system database for electronic storage (block 500) and available for processing and/or presentment on a system website. This data may then be electronically reported to users authorized to receive such information, as represented by block 600. This data may also, or alternatively, be compared with data previously generated identifying the customer distribution center shipping containers slated for delivery to test center 40, and any variance may be electronically reported immediately to users through an appropriate alert notification such as an email alert or posting data on a system website.

The customer distribution center shipping containers may be opened and the test materials shipped therein may be removed for further sorting or processing prior to delivery to test taking. The test materials are scanned individually upon removal from the customer distribution center shipping containers (block 700) and data is thereby generated indicating which test materials were received in which shipping containers. This data is transmitted to the system database for electronic storage (block 500) and available for processing and/or presentment on a system website. This data may then be electronically reported to users authorized to receive such information, as represented by block 600. This data may also, or alternatively, be compared with data previously generated indicating the content of each customer distribution center shipping container slated for delivery to test center 40, and any variance may be electronically reported immediately to users through an appropriate alert notification, such as an email alert or posting data on a system website.

In some applications, the exceptions or variance can be electronically reported (through email or posting on a system website, for example), indicating that an insufficient number of test materials were received by test center 40. Under such circumstances, customer distribution centers 20 receiving a larger quantity of test materials than required by their respective test centers 40 may generate shipping labels at the system website for shipping and monitoring of test materials sent to the test centers 40 having insufficient test materials. These functions may also be performed on a customer distribution center to customer distribution center level, such as between two customer distribution centers 20, or between a first customer distribution center 20 and a second customer distribution center 30 (see FIG. 1). For example, state school systems may distribute any overage of test materials to school districts or individual schools having an underage of test materials. Similarly, school districts may distribute any overage of test materials to other school districts or individual schools having an underage of test materials. Furthermore, individual schools may distribute any overage of test materials to other schools having an underage of test materials, typically within the same school district. School districts may desire to control this distribution between individual schools or may authorize the individual schools to carry out those functions.

The individual test materials are then distributed to the test takers (block 440) and scanned as distributed (block 700). Data is thereby generated indicating that the test materials will be used for test taking purposes. This data is transmitted to the system database for electronic storage (block 500) and available for processing and/or presentment on a system website. This data may then be electronically reported to users authorized to receive such information, as represented by block 600, and will identify the quantity of tests of those received by the test center 40 that will be used.

In the case where the identifier for test materials is unique and based upon the identity of the test taker that will use specific test materials, this information may also be delivered to the system database (block 500) and reported as described herein throughout (block 600).

The tests are then completed by the test takers (block 460), typically under supervision of at least one test monitor. Following completion of the tests, the return or recovery process is initiated. The test materials are collected from the test takers (block 430).

The test materials are thereafter prepared for delivery to customer distribution center 20, as also represented by block 450. In particular, the test materials (preferably both used and unused materials) to be delivered to the customer distribution center 20 are packed in test center shipping containers. The bar code or RFID transponder for each test material is scanned prior to placement within a test center shipping container, as represented by block 700. Each such shipping container may also have a bar code or RFID transponder associated therewith, which may be placed directly on the shipping container or may be placed on a pallet or similar structure used to carry out the delivery of a plurality of shipping containers. In the case where the bar code or RFID transponder associated with a particular test center shipping container is placed on a pallet or similar structure, the bar code or RFID transponder may be used to identify a plurality of such shipping containers.

Data pertaining to the quantity of test materials and/or the identity of each test material packed within a specific test center shipping container or within one of a plurality of such shipping containers is transmitted to the system database for electronic storage and available for processing and/or presentment on a system website, as represented by block 500

After a test center shipping container has been filled, or after the final test material designated for shipment to the customer distribution center 20 has been packed within such a shipping container, the shipping container is sealed for shipment. At such time, the bar code or RFID transponder associated with one or more test center shipping containers may be scanned, as represented by block 700, and data pertaining to the identity of such shipping containers and/or their contents is transmitted to the system database for electronic storage and available for processing and/or presentment on a system website, as represented by block 500. The transmitted scanned data also may identify the quantity of the test center shipping containers and test materials being sent from the test center 40.

This data may then be electronically reported to users authorized to receive such information, as represented by block 600. This data may also, or alternatively, be compared with data generated identifying the quantity of test materials sent to the testing center 40 to identify any variance. Any such variance may be electronically reported immediately to users authorized to receive such information, as also represented by block 600, to alert the users of errors and the source of errors within the test materials chain of custody such as an email alert or posting data on a system website.

A carrier may pick up and attend to shipment of the test center shipping containers from the test center 40 along return path segment 25, as represented by block 450. The carrier may scan the bar codes or RFID transponders associated with the test center shipping containers (block 700).

In response, data indicating that the associated shipping containers have been received by the carrier for shipment is transmitted to the system database for electronic storage (block 500) and available for processing and/or presentment on a system website. This data may then be reported to users authorized to receive such information, as represented by block 600. This data may also, or alternatively, be compared with previously scanned data and any variance may be electronically reported immediately to users through an appropriate alert notification such as an email alert or posting data on a system website.

The carrier then may deliver the test center shipping containers and the test materials contained therein to the customer distribution center 20 along return path segment 25, as represented by block 450. At the customer distribution center 20, the test center shipping containers are received (block 230), and the bar codes or RFID transponders associated with the shipping containers are scanned (block 700). Data indicating that the associated test center shipping containers have been delivered to and received by the customer distribution center 20 is transmitted to the system database for electronic storage (block 500) and available for processing and/or presentment on a system website. This data may then be electronically reported to users authorized to receive such information, as represented by block 600. This data may also, or alternatively, be compared with data previously generated identifying the test center shipping containers slated for delivery to customer distribution center 20, and any variance may be electronically reported immediately to users through an appropriate alert notification such as an email alert or posting data on a system website.

The test center shipping containers may be used to deliver the test materials to the publisher distribution center 10 or other scoring center. Alternatively, at the customer distribution center 20, the test center shipping containers may be opened and the test materials shipped therein may be removed for further sorting or processing prior to delivery to the scoring center, as represented by block 250.

The test materials are scanned individually upon removal from the test center shipping containers (block 700) and data is thereby generated indicating which test materials were received in which shipping containers. This data is transmitted to the system database for electronic storage (block 500) and available for processing and/or presentment on a system website. This data may then be electronically reported to users authorized to receive such information, as represented by block 600. This data may also, or alternatively, be compared with data previously generated indicating the content of each test center shipping container slated for delivery to customer distribution center 20, and any variance may be electronically reported immediately to users through an appropriate alert notification such as an email alert or posting data on a system website.

As represented by block 270, the test materials are thereafter prepared for delivery to the scoring center, which is shown for illustrative purposes as being the publisher distribution center 10. It will be appreciated that the scoring center may be a center other than the publisher distribution center 10.

The test materials are packed in customer distribution center shipping containers for return to publisher distribution center/scoring center 10. The bar code or RFID transponder for each test material is scanned prior to placement within a customer distribution center shipping container, as represented by block 700. Each such shipping container may also have a bar code or RFID transponder associated therewith, which may be placed directly on the shipping container or may be placed on a pallet or similar structure used to carry out the delivery of a plurality of shipping containers. In the case where the bar code or RFID transponder associated with a particular test center shipping container is placed on a pallet or similar structure, the bar code or RFID transponder may be used to identify a plurality of such shipping containers.

Data pertaining to the quantity of test materials and/or the identity of each test material packed within a specific customer distribution center shipping container or within one of a plurality of such shipping containers is transmitted to the system database for electronic storage and available for processing and/or presentment on a system website, as represented by block 500.

After a customer distribution center shipping container has been filled, or after the final test material designated for shipment to the publisher distribution center 10 has been packed within such a shipping container, the shipping container is sealed for shipment. At such time, the bar code or RFID transponder associated with one or more customer distribution center shipping containers may be scanned, as represented by block 700, and data pertaining to the identity of such shipping containers and/or their contents is transmitted to the system database for electronic storage and available for processing and/or presentment on a system website, as represented by block 500. The transmitted scanned data also may identify the quantity of the customer distribution center shipping containers and test materials being sent from the customer distribution center 40.

This data may then be electronically reported to users authorized to receive such information, as represented by block 600. This data may also, or alternatively, be compared with data generated identifying the quantity of test materials sent to the customer distribution center 20 to identify any variance. Any such variance may be electronically reported immediately to users authorized to receive such information, as also represented by block 600, to alert the users of errors and the source of errors within the test materials chain of custody such as an email alert or posting data on a system website.

A carrier may pick up and attend to shipment of the customer distribution center shipping containers from the customer distribution center 20 along return path segment 25, as represented by block 270. The carrier may scan the bar codes or RFID transponders associated with the customer distribution center shipping containers (block 700).

In response, data indicating that the associated shipping containers have been received by the carrier for shipment is transmitted to the system database for electronic storage (block 500) and available for processing and/or presentment on a system website. This data may then be reported to users authorized to receive such information, as represented by block 600. This data may also, or alternatively, be compared with previously scanned data and any variance may be electronically reported immediately to users through an appropriate alert notification such as an email alert or posting data on a system website.

The carrier then may deliver the customer distribution center shipping containers and the test materials contained therein to the publisher distribution center 10 along return path segment 25, as represented by block 270. At the publisher distribution center 10, the customer distribution center shipping containers are received (block 130), and the bar codes or RFID transponders associated with the shipping containers are scanned (block 700). Data indicating that the associated customer distribution center shipping containers have been delivered to and received by the publisher distribution center 10 is transmitted to the system database for electronic storage (block 500) and available for processing and/or presentment on a system website. This data may then be electronically reported to users authorized to receive such information, as represented by block 600. This data may also, or alternatively, be compared with data previously generated identifying the customer distribution center shipping containers slated for delivery to publisher distribution center 10, and any variance may be electronically reported immediately to users through an appropriate alert notification such as an email alert or posting data on a system website.

At the publisher distribution center 10, the customer distribution center shipping containers may be opened and the test materials shipped therein may be removed for further sorting or processing prior to scoring, as further represented by block 130.

The test materials are scanned individually upon removal from the customer distribution center shipping containers (block 700) and data is thereby generated indicating which test materials were received in which shipping containers. This data is transmitted to the system database for electronic storage (block 500) and available for processing and/or presentment on a system website. This data may then be electronically reported to users authorized to receive such information, as represented by block 600. This data may also, or alternatively, be compared with data previously generated indicating the content of each customer distribution center shipping container slated for delivery to customer distribution center 20, and any variance may be electronically reported immediately to users through an appropriate alert notification such as an email alert or posting data on a system website.

The test materials are then scored (block 150), if used. All test materials (both used and unused) are scanned individually. Data is thereby generated indicating the identity and/or quantity of tests scored and not scored. This data is transmitted to the system database for electronic storage (block 500) and available for processing and/or presentment on a system website. This data may then be electronically reported to users authorized to receive such information, as represented by block 600. This data may also, or alternatively, be compared with data previously generated identifying the quantity of total tests returned, total tests to be scored and/or total tests not to be scored, and any variance from expected values may be electronically reported immediately to users through an appropriate alert notification such as an email alert or posting data on a system website.

It will be appreciated by those skilled in the art that the data scanning at each stage of the chain of custody process of the present invention can be accomplished with a variety of technologies. For example, the documents and shipping containers could have a bar code label attached that is scanned by a bar code scanner. Radio Frequency Identification (RFID) is another technology that could be used for data capture and scanning. In addition, the scanned data could be posted to the same website at every step of the chain of custody process for standardized tests. Alternatively, scanned data at each step could be posted to different or multiple websites. Further, scanning and posting data to a website may occur at some and not all stages of the chain of custody, as described.

It will be further appreciated that there may be any number of customer distribution centers, including none, depending upon the needs and capabilities of individual customers. In addition, the completed test materials may be delivered to a scoring center controlled by the publisher or a third party.

It will be even further appreciated by those skilled in the art that while this invention has been described with reference to certain illustrative embodiments, it will be understood that this description shall not be construed in a limiting sense. Rather, various changes and modifications can be made to the described embodiments without departing from the true spirit and scope of the invention, as defined by the following claims. Furthermore, it will be appreciated that any such changes and modifications will be recognized by those skilled in the art as an equivalent to one or more elements of the following claims, and shall be covered by such claims to the fullest extent permitted by law.

1. A method for monitoring movement of tests distributed from a first facility to a second facility, comprising:
utilizing a test material, wherein said test material has a machine readable test identifier associated therewith;
utilizing a shipping container for containing said test material in transit, wherein said shipping container has a machine readable shipping container identifier associated therewith;
sending said shipping container containing said test from a first facility to a second facility separate from said first facility and located geographically remote from said first facility;
having each machine readable test identifier scanned at said first facility;
having each machine readable shipping container identifier scanned at said first facility;
having each machine readable test identifier scanned at said second facility;
having each machine readable shipping container identifier scanned at said second facility;
electronically reporting data related to said scanning steps to a person authorized to receive said data.

2. The method of claim 1 wherein the machine readable test identifier is used to obtain a test material quantity of tests to be sent to said second facility.

3. The method of claim 1 wherein the machine readable shipping container identifier is used to obtain a shipping container quantity of shipping containers to be sent to said second facility.

4. The method of claim 1 wherein the electronic reporting step is carried out by posting said data to a website for viewing by said person.

5. The method of claim 1 wherein the electronic reporting step is carried out by sending an electronic mail message to said person.

6. The method of claim 1 further comprising the step of comparing first data related to scanning at the first facility and second data related to scanning at the second facility.

7. The method of claim 6 wherein the electronic reporting step comprises reporting to said person that said comparison indicates that said shipping container was received at said second facility.

8. The method of claim 6 wherein the electronic reporting step comprises reporting to said person that said comparison indicates that said test material was received at said second facility.

9. The method of claim 1 wherein the machine readable test identifier is a bar code label.

10. The method of claim 1 where the machine readable shipping container identifier is a bar code label.

11. The method of claim 1 wherein the machine readable test identifier is a radio frequency identification tag.

12. The method of claim 1 wherein the machine readable shipping container identifier is a radio frequency identification tag.

13. The method of claim 1 wherein said first facility is a test publisher distribution center and said second facility is a test center.

14. The method of claim 13 wherein said test center is a school classroom.

15. The method of claim 1 wherein said first facility is a test publisher distribution center and said second facility is a customer distribution center.

16. The method of claim 15 wherein said customer distribution center is selected from the group consisting of a school district and a school.

17. The method of claim 1 wherein said first facility is a customer distribution center and said second facility is a test center.

18. The method of claim 17 wherein said customer distribution center is selected from the group consisting of a school district and a school.

19. The method of claim 17 wherein said test center is a school classroom.

20. The method of claim 1 wherein said first facility is a test center and said second facility is a customer distribution center.

21. The method of claim 20 wherein said test center is a school classroom.

22. The method of claim 17 wherein said customer distribution center is selected from the group consisting of a school district and a school.

23. The method of claim 1 wherein said first facility is a test center and said second facility is a scoring center.

24. The method of claim 23 wherein said test center is a school classroom.

25. The method of claim 1 wherein said first facility is a customer distribution center and said second facility is a scoring center.

26. The method of claim 25 wherein said customer distribution center is selected from the group consisting of a school district and a school.
